(19) United States
(12) Patent Application Publication
(10) Pub. No.: US 2006/0145482 A1
(43) Pub. Date: Jul. 6, 2006

(54) Vehicle powertrain that compensates for a prime mover having slow transient response

(76) Inventors: Bob Roethler, Howell, MI (US); Cliff Carlson, Fenton, MI (US); Robert Lippert, Ann Arbor, MI (US); Ron Kepner, Ann Arbor, MI (US); John Brevick, Livonia, MI (US)

Correspondence Address: MACMILLAN, SOBANSKI & TODD, LLC, ONE MARITIME PLAZA - FOURTH FLOOR, 720 WATER STREET, TOLEDO, OH, 43604, US

(21) Appl. No.: 11/030,237

(22) Filed: Jan. 6, 2005

(51) Int. Cl. H02P 9/04; F02D 29/06

(52) U.S. Cl. 290/40 C

(57) ABSTRACT

A powertrain for transmitting power in a vehicle includes a prime mover having a relatively slow transient response, and a storage device for storing energy in a predetermined form. A transmission includes an input driveably connected to the prime mover and an output driveably connected to vehicle drive wheels, producing a range of ratios of a speed of the output to a speed of the input that varies from negative to positive and includes zero. An energy conversion device, driveably connected to the prime mover and drive wheels, converts rotational power transmitted to the energy conversion device from the wheels and the prime mover to a form of energy that can be stored in the storage device, and drives the wheels using energy supplied to the energy conversion device from the storage device. A control device alternately transmits energy from the storage device to the energy conversion device, and transmits energy from the energy conversion device to the storage device.

### BACKGROUND OF THE INVENTION

The invention relates in general to a vehicle powertrain. In particular, the invention pertains to a powertrain that provides the driver with an acceptable response to a command for a change in wheel torque even though the prime mover is slow to respond to the command.

Certain types of internal combustion engines and fuel cell systems can provide high efficiency and low emissions, but with relatively slow transient load and speed response. This slow transient response is not acceptable for vehicles with conventional drivelines.

Certain types of transmissions provide acceptable vehicle transient response even with slow transient response engines. The basic features of these transmissions include an infinitely variable drive ratio, and reversible torque machines with energy storage. An infinitely variable transmission (IVT) is a transmission that produces an infinite speed ratio span and continuous speed ratio variation.

Internal combustion engine development has been concentrated on efficient power sources such as engines and combustion systems that produce low exhaust gas emissions. Gasoline engines that use homogeneous charge compression ignition (HCCI) combustion show potential to operate as efficiently as a diesel engine, yet emit a very low volume of NOx compounds in the exhaust gas. However, on a fixed compression ratio basis, a HCCI combustion system is five to ten times slower in response to load changes than a stoichiometric, port fuel injected, spark ignited combustion system, the current production baseline engine.

Slow dynamic engine response requires both speed isolation and load isolation to produce acceptable performance. The key powertrains for producing speed and load isolation include series electric, series hybrid, power-split electric and power-split hydraulic. The prime mover would be suitably decoupled from the drive wheels, as in most conventional high power hybrid powertrains.

An energy storage media onboard the vehicle supplements energy derived from engine fuel. The energy storage media must be capable of powering the vehicle for the length of the period while the prime mover is adjusting to the new load state, about one to five seconds. Both hydraulic and electric hybrid architectures may be used to provide the auxiliary energy storage, preferably hydraulic energy storage systems for heavy vehicles and electric systems for light vehicles.

Energy stored in hydraulic fluid accumulators, electric batteries, capacitors, or flywheels can be used in combination with reversible machines, such as hydraulic pump/motors and electric motors, to accelerate the vehicle in response to the driver's demand for increased wheel torque, while the prime mover is moving from an idle state to a full load state. The stored energy reserve can be recovered from regenerative wheel braking or it can be produced by the prime mover while road load is low.

There is a need to provide a powertrain having components that compensate for the inherently slow dynamic response of a prime mover such as an IC engine or other power source to provide the operator with an acceptable, timely response to speed and load transient demands.

### SUMMARY OF THE INVENTION

In hybrid vehicles, the energy storage device is controlled and managed such that fuel use is minimized. Generally, hybrid electric vehicle powertrains are designed with battery systems that have power capacity significantly less than that of the prime mover's maximum power rating. The battery is compromised in this way because the cost and mass of a battery that would achieve both high power and a small state of charge excursion, a requirement for satisfactory service life, is too great.

This invention goes beyond the currently known hybrid implementations in managing stored power to supplement the prime mover specifically in transient situations where the vehicle operator is requiring a rapid rise in wheel power but the prime mover cannot respond sufficiently. An advantage of the control produced by this invention is augmenting the power output produced by prime mover, thereby producing a higher average load factor and high efficiency and allowing use of a smaller than normal prime mover in the powertrain.

Another advantage of this invention is the ability to use an efficient, clean combustion system having slow load response as the prime mover in a vehicle having excellent dynamic response. To accomplish this advantage a powertrain according to this invention uses an infinitely variable transmission and an energy storage device specifically to isolate the engine from vehicle transient speed and load demands.

A powertrain according to this invention can use a brake-by-wire regenerative braking system that prioritizes deceleration torque first from the transmission and second from the friction wheel brakes. The regenerative braking system is compatible with anti-lock braking, traction control and vehicle dynamic safety systems.

A powertrain according to this invention is compatible with two-wheel and four-wheel drive drivelines. All-wheel-drive operation can be accomplished with a transfer case and mechanical link to a second set of wheels. Alternately, all-wheel-drive operation can be accomplished with an additional reversible machine, compatible with the transmission reversible machine, on the other set of wheels. This can provide additional kinetic energy recovery as well as maximum acceleration and wheel traction on a road surface with a low.

The transmission can be use with a compression ignition (CI) engine, such as a diesel engine. Particulate emissions can be reduced because slow transient load response is accommodated with the transmission. A lower cost turbocharger can be used since fast transient load response is not required from the engine.

A powertrain according to this invention for transmitting power in a vehicle includes a prime mover having a relatively slow transient response, and a storage device for storing energy in a predetermined form. A transmission includes an input driveably connected to the prime mover and an output driveably connected to vehicle drive wheels. The transmission produces a range of ratios of a speed of the output to a speed of the input that varies from negative to positive and includes zero. An energy conversion device, driveably connected to the prime mover and drive wheels, converts rotational power transmitted to the energy conversion device from the wheels and the prime mover to a form of energy that can be stored in the storage device, and drives the wheels using energy supplied to the energy conversion device from the storage device. A control device alternately transmits energy from the storage device to the energy conversion device, and transmits energy from the energy conversion device to the storage device.

Various objects and advantages of this invention will become apparent to those skilled in the art from the following detailed description of the preferred embodiment, when read in light of the accompanying drawings.

### BRIEF DESCRIPTION OF THE DRAWINGS

FIG. 1 is a schematic diagram of a hybrid powertrain for a motor vehicle;

FIG. 2 is a schematic diagram of a transmission whose hydraulic components are coupled to the transmission output;

FIG. 3 is a schematic diagram of a transmission whose hydraulic components are coupled to the transmission input;

FIG. 4 is a schematic diagram of an alternative transmission whose electric components are coupled to the transmission output;

FIG. 5 is a schematic diagram of a hydrostatic transmission whose pump and motor have variable displacement;

FIG. 6 is a schematic diagram of a hydrostatic transmission having a variable displacement pump and motor, and accumulators communicating with a high pressure circuit and low pressure circuit, respectively; and

FIG. 7 is a schematic diagram of a dual mode powertrain.

### DETAILED DESCRIPTION OF THE PREFERRED EMBODIMENT

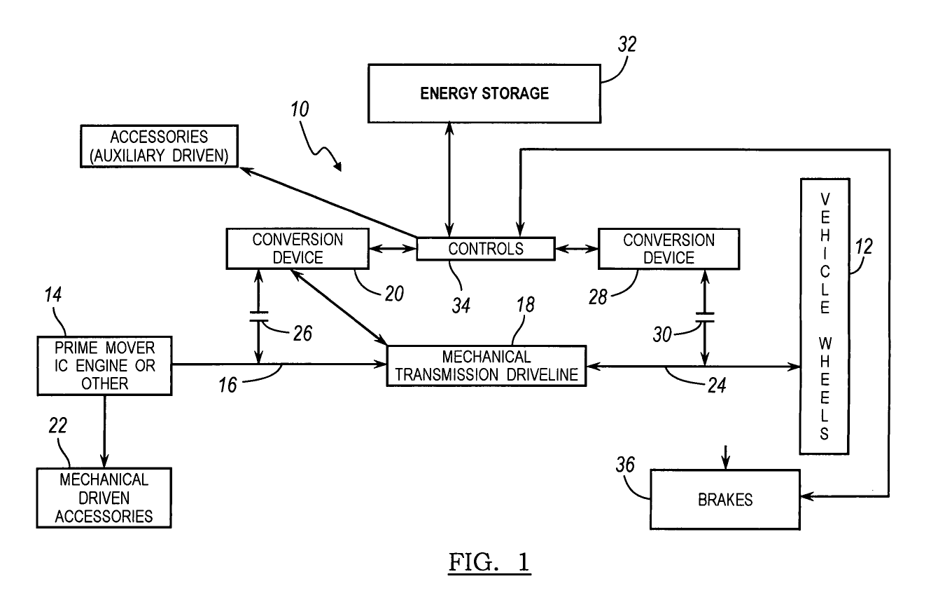

Referring now to the drawings, there is illustrated in FIG. 1 a general arrangement of a hybrid powertrain 10 for transmitting power between the driven wheels 12 of a vehicle and a prime mover 14. The powertrain prime mover 14, preferably an internal combustion engine (ICE), whose output 16 is driveably connected to an input of a mechanical transmission 18 and to an energy conversion device 20, such as an electric motor-generator set, a hydraulic pump/motor, or another such reversible machine. The prime mover 14 may directly drive mechanical accessories 22, such as an air conditioning compressor, power steering pump, superchargers, etc.

The transmission output 24, which is driveably connected to the vehicle wheels 12, may drive the wheels or be driven by the wheels depending on the powertrain operating conditions, the speed of the wheels, the current operating speed ratio of the transmission, and speed of the prime mover output 16. The transmission input 16 is driveably connected selectively to the conversion device 20 through a releasable clutch 26. Preferably, when the prime mover 14 produces little or no output power, the clutch 26 transmits power from the conversion device 20 to the transmission input 16; otherwise, clutch 26 is disengaged. Alternatively, the transmission output 24 is driveably connected selectively to an energy conversion device 28 through a releasable clutch 30.

Energy produced by the conversion devices 20, 28 is stored temporarily and replenished periodically in a energy storage device 32, subject to a control system 34, which determines the current capacity of the storage device 32, the energy producing capability of the conversion devices 20, 28, the vehicle operating conditions, and the likely need for energy from storage device 32 to meet driver demands and road conditions.

Wheel brakes 36, which many be mechanically or electrically connected to a brake pedal operated manually by the vehicle operator, are subject to control by the control system 34. Energy required to stop the vehicle in response to a demand of the operator may be recovered in the form of vehicle kinetic energy converted by devices 20, 28 to electric, hydraulic or kinetic energy of a flywheel. That energy is stored in the device 32 for later use to drive the vehicle wheels 12.

To best apply the advantages of this invention, the prime mover 14 would be characterized by slow load and speed response and preferably would include any of the following group: a homogeneous charge compression ignition (HCCI) gasoline ICE, HCCI diesel ICE, and turbocharged diesel ICE. Less preferred alternatives include a Stirling engine, a fuel cell stack in combination with a series electric transmission, i.e., an electric generator driven by an ICE, and an electric motor driven by a generator and driveably connected to the driven wheels.

All of these prime movers have slow transient response. Throughout this discussion the term “slow response” means a period for the prime mover to respond to a command for a change in torque that is too slow for use in a conventional on-road application, i.e., a prime mover that requires more than 1-2 seconds response time to pass from the prime mover idling with no commanded wheel torque to the prime mover producing full torque, but not necessarily full power.

Internal Combustion Engine Transient Torque Response

The transient torque response of Otto cycle and Diesel cycle ICEs depends on many factors related to the nature of naturally aspirated engines. Otto cycle engines are influenced by the effect of ambient conditions on the speed of sound at the intake manifold, and inertia of the engine, accessories, and torque converter. Intake manifolds having lower volume between the throttle and inlet valve will have better transient torque response.

Torque response of an engine whose intake is boosted by mechanically driven devices, such as superchargers, is affected by the response of any clutch or bypass device in the intake system, and any increase in intake manifold volume. Torque response of an engine whose intake is boosted by exhaust gas energy, such a turbocharger, includes the time to generate intake manifold pressure, time to increase exhaust energy, and time to accelerate the inertia of the turbine and compressor. The torque response is also affected by an increase in intake manifold volume from the engine throttle to intake valve including the effect of an intercooler.

Exhaust gas recirculation (EGR) systems also affect transient torque response (e.g., part load to full load transient), because the EGR valve must close in response) to a control system command, and the exhaust gas must purge from the intake manifold. The response is a function of the EGR rate, and the volume of space in the intake system from the EGR valve to the inlet valve.

The fuel system must be able to respond appropriately to the air captured in each cylinder and must maintain a fuel-air mixture in the cylinders that is stoichiometric, or nearly so. Transient torque response for a spark ignition, Otto cycle, stoichiometric ICE is approximately 150 Ms.

Transient response of turbocharged diesel engines is influenced by particulate emissions. Even using higher-pressure fuel systems with smaller nozzle holes, there is a particulate emissions limit for each combustion system operating somewhat leaner than stoichiometric. A transient from idle to full load is the worse case, and the torque response is a function of the fuel ramp-up, which is a function of the particulate emissions limit and the ramp-up of intake manifold pressure, i.e., turbocharger response. Secondary effects include response times associated with engine, accessory, and torque converter inertia.

As emission requirements become more stringent, particulate emissions limits become lower, and EGR rates increase. Both these changes increase the transient torque response time of a diesel engine. Higher rates of EGR reduce flow to the turbine of the turbocharger.

Inlet boost level response directly influences the allowable fuel rate ramp-up during an idle to high load transient. Variable geometry or compound turbochargers are used to improve the transient response, but both of these techniques are expensive, and there is very little energy in the diesel exhaust gas at idle.

Diesel powertrains that meet emission requirements may have transient torque delays from idle of about two 2 seconds.

Homogeneous Charge Compression Ignition

Both diesel and gasoline fueled HCCI combustion systems are currently being developed. A homogeneous fuel-air mixture, usually accomplished by injecting fuel into an intake manifold, in which the airflow is turbulent or swirling so that the mixture is homogenous as it enters the cylinder, characterizes a HCCI engine. Ignition occurs in normal operation without a spark plug, glow plug, or other heat source, but instead due to a relatively high compression ratio, although spark ignition may be used to start a cold HCCI if ambient conditions so require.

Gasoline HCCI engines have the potential benefits of low emissions, e.g., no NOx emissions during cold combustion, and high efficiency due to no throttling, high compression ratio, and fast lean combustion. After-treatment cost is low compared to a diesel engine or lean SI engine because an oxidation-only catalyst is required. Port fuel injection can be used instead of high pressure in-cylinder fuel injection in conventional engines. A turbocharger is required to achieve reasonable specific output, and internal and external EGR systems are required.

Timing the combustion event is a fundamental challenge for HCCI engines, because inlet conditions time the combustion event rather than a spark or injection event. If the inlet conditions are not correct, combustion may not occur, or it occurs either early, causing high cylinder pressure and low work/efficiency, or late, causing low work/efficiency. Inlet temperature, internal/external EGR, and boost level must be controlled in gasoline HCCI engines. These controls are inherently slow, and result in transient torque delays of about five seconds.

An infinitely variable transmission (IVT) is a transmission having an input and an output, and the ability to produce a range of speed ratios, i.e., a ratio of the output speed to the input speed, that varies from negative to positive and includes zero, while continually maintaining the input and output mutually driveably connected. For purposes of this invention the transmission 18 may include any of the following IVTs: a series electric transmission, such a series arrangement of an electric generator, motor and driven wheels driveably connected to the adjacent component in consecutive order; a series hydraulic or hydrostatic transmission; a power-split electric, also known as an EVT; a power-split hydraulic or hydromechanical transmission; and a power-split mechanical transmission, e.g., a traction drive transmission of the type described in U.S. Pat. No. 5,967,931, which is assigned to the Assignee of the present invention.

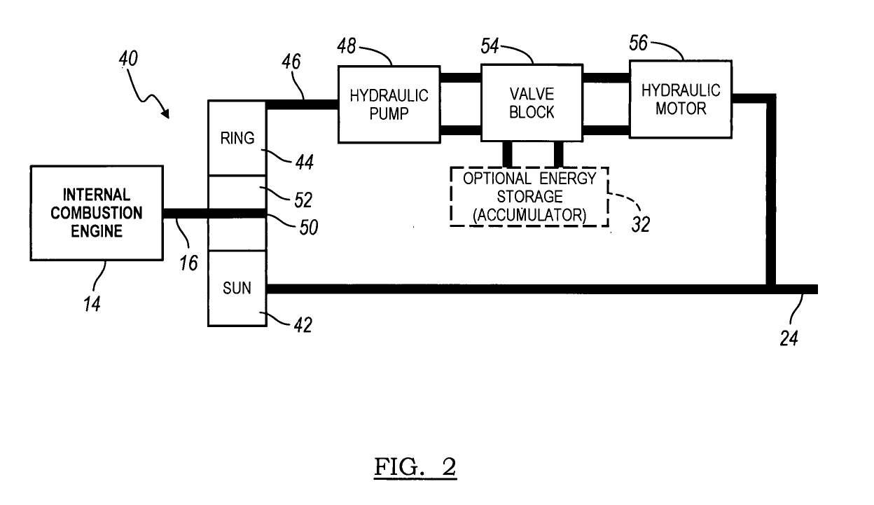

FIG. 2 illustrates a transmission 18, in which hydraulic components are coupled to the transmission output 24, and the output of the prime mover 14, an ICE, is driveably connected to the transmission input 16. A planetary gearset 40 includes a sun gear 42, which is driveably connected to the output 24; a ring gear 44, which is driveably connected to the shaft 46 of a fluid pump 48, preferably a hydraulic pump; a carrier 50, connected to the input 16; and planet pinions 52 meshing with the sun gear and ring gear. The energy storage device 32 is a hydraulic accumulator, which stores fluid under pressure. The accumulator 32 communicates through a valve block 54 alternately with the hydraulic pump 48 and a hydraulic motor 56, which is driven by pressurized fluid from the pump, the accumulator, or pump and accumulator combined. The motor 56 is driveably connected to the wheels 12 through the transmission output 24.

In operation, when the speed of carrier 50 is less than the speed of the ring gear 44, output 24 is driven in a reverse direction. When the speed of carrier 50 is equal to the speed of the ring gear 44, output 24 is stopped. When the speed of carrier 50 is greater than the speed of the ring gear 44, output 24 is overdriven in a forward direction. Controller 34 controls the speed of the ring gear 44 in accordance with the state of valves in the valve body 54, the speed and displacement of the motor 56 and pump 48, and pressure in the accumulator 32. The speed and torque ratios are kinematically determinate.

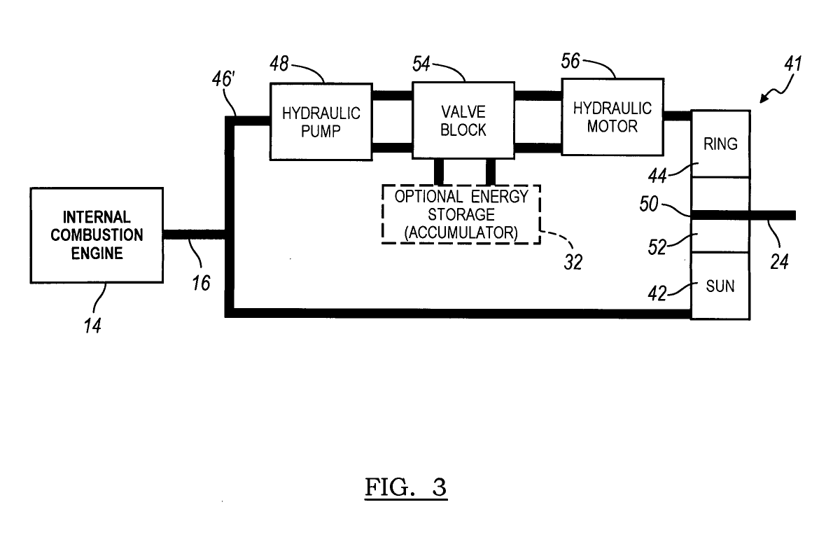

FIG. 3 illustrates a transmission, in which hydraulic components are coupled to the transmission input 16, and the transmission output 24 is coupled to the driven wheels 12. The output of prime mover 14, an ICE, is driveably connected also to the transmission input 16. The planetary gearset 41 includes a sun gear 42, which is driveably connected to the input 16; a ring gear 44, which is driveably connected to the hydraulic motor 56; a carrier 50, connected to the output 24; and planet pinions 52 meshing with the sun gear and ring gear. The energy storage device 32 is a hydraulic accumulator, which stores fluid under pressure. The accumulator 32 communicates through the valve block 54 alternately with the hydraulic pump 48 and a hydraulic motor 56, which is driven by pressurized fluid from the pump, the accumulator, or pump and accumulator combined. The hydraulic pump 48 is driveably connected to the input 16.

In operation, controller 34 controls the speed and direction of the ring gear 44 in accordance with the state of valves in the valve body 54, the speed and displacement of the motor 56 and pump 48, and pressure in the accumulator 32. When the speed of ring gear 44 is greater than the speed of the sun gear 44 and is in the opposite direction, carrier 50 and output 24 are in a reverse direction. When the speed of ring gear 44 is equal to the speed of the ring gear 44 and is in the same direction, carrier 50 and output 24 are stopped. When the speed of ring gear 44 is greater than the speed of the ring gear 44 and is in the same direction, carrier 50 and output 24 are overdriven in a forward direction. The speed and torque ratios are kinematically determinate.

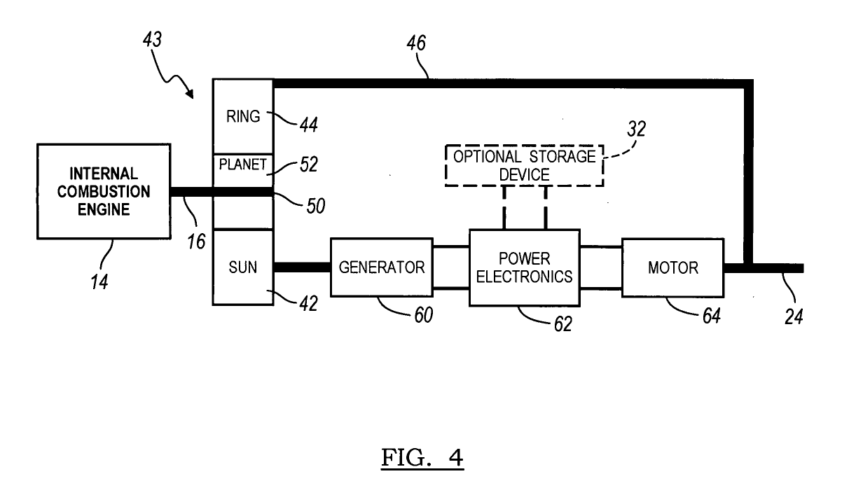

FIG. 4 is a schematic diagram of a transmission, whose electric components are coupled to the transmission output 24 and wheels 12, and whose input 16 is connected to a power splitting planetary gearset 43. The electric components include an electric generator 60, power control electronics 62, and electric motor 64, which is driveably connected through the power electronics to an electric power source 32. The optional energy storage device 32 is a preferably an electric battery, but may be multiple electric capacitors. The output of prime mover 14, an ICE, is driveably connected also to the transmission input 16 and carrier 50. The planetary gearset 43 includes a sun gear 42, which is driveably connected to generator 60; a ring gear 44, which is driveably connected through shaft 46 to the output 24; a carrier 50, connected to the input 16; and planet pinions 52 meshing with the sun gear and ring gear.

In operation, electronic controller 62 controls the speed of the generator 60 and the speed and output torque of the motor 64. When the speed of sun gear 42 and generator 60 is greater than the speed of carrier 50, ring gear 44 and output 24 are underdriven in the reverse direction. When the speed of sun gear 42 and generator 60 is equal to the speed of the carrier 50, ring gear 40 and output 24 are stopped. When the speed of sun gear 42 and generator is less than the speed of the ring gear 44, ring gear 40 and output 24 are overdriven in a forward direction. The output speed and torque ratio are not kinematically constrained.

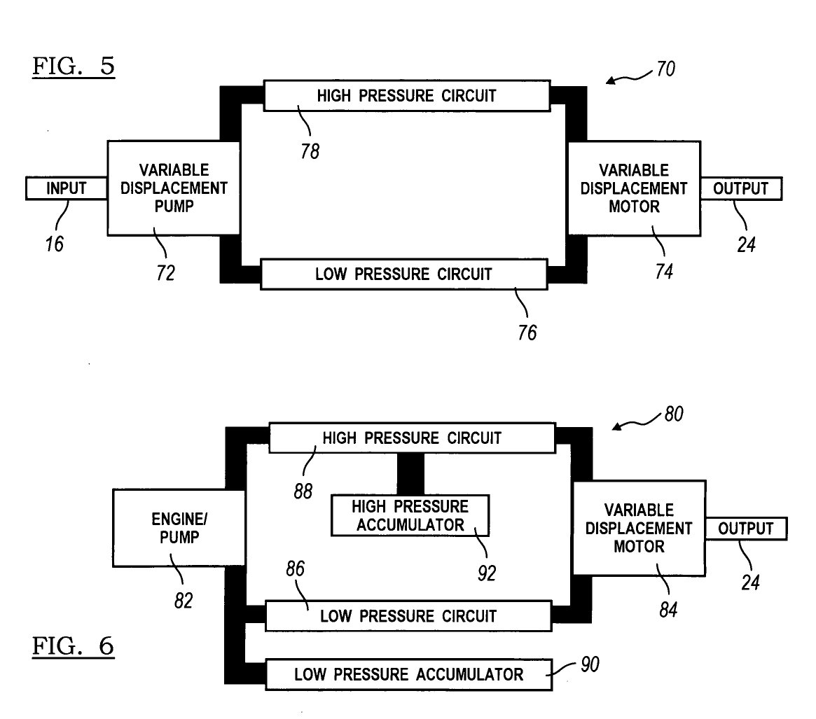

FIG. 5 is a schematic diagram of a hydrostatic transmission 70, which includes a hydraulic pump 72, driveably connected to the input 16, and a hydraulic motor 72, driveably connected to the output 24. Both the pump 72 and motor 74 have variable displacement. The pump 72 communicates with a low pressure circuit 76, from which fluid is pumped to a high pressure circuit 78. The motor 74, driven by fluid from circuit 78, communicates with the low pressure circuit 76, to which fluid returns from the motor.

When displacement of the pump 72 is zero and the prime mover engine is running, the wheels 12 of the vehicle are not driven because the output 12 is locked. When displacement of the motor 74 is zero, the input 16 is locked, the output is free to rotate, and a clutch is required in the drive path between the engine 14 and the pump 72 if the engine is to run with the wheels 12 stopped. When displacement of the pump 74 is reaches its maximum, displacement of the pump 72 can be reduced, thereby overdriving the output 24 relative to the speed of the input 16.

FIG. 6 is a schematic diagram of a hydrostatic transmission 80, which includes a internal combustion engine/pump 82; a variable displacement hydraulic motor 84, driveably connected to the output 24; a low pressure circuit 86; a high pressure circuit 88; a low pressure fluid accumulator 90 communicating with circuit 86; and a high pressure fluid accumulator 92 communicating with circuit 88. Pressure in the accumulators 90, 92 determines the magnitude of pressure in the circuits 86, 88, respectively. However, the instantaneous fluid flow rate and power produced by the engine/pump 82 need not be equal to those at the motor 84 and the output 24 because the accumulators 90, 92 either receive or contribute flow and energy in order to conserve the flow rate and energy in the transmission system.

For purposes of this invention, the storage device 32 may include one of the following, provided it is functionally compatible with the other powertrain components: a hydraulic accumulator containing hydraulic or pneumatic fluid under high pressure of about 5000 psi.; an electric battery assisted by a secondary capacitor stack; an electric battery preferably having capacity to produce at least 25 percent of the rated power of the prime mover; and a flywheel with an appropriate electric, hydraulic or mechanical interface device.

The control system 34 is selected to be appropriate to the transmission type, i.e., a hydraulic valve block and an appropriate electronic control system that controls operation of the valve block for a transmission having hydraulic or pneumatic components, or a power electronics controller for a transmission having an electric motor and generator.

The stored energy 32 supplements the prime mover specifically during transient load conditions when the vehicle operator is demanding a rapid rise in wheel torque, but the prime mover 14 cannot respond to the demand in sufficient time to satisfy the operator's expectations.

The transmission 18 is preferably an IVT, as described above, so that the engine speed is effectively decoupled from the vehicle speed or wheel speed, but can still add power to the engine's instantaneous power capability.

The storage device, the associated controls, and the reversible machines, i.e., the electric generator-motors and hydraulic pump-motors, should have sufficient capacity to increase power at the wheels 12 during transient conditions, not by a fixed amount, but depending on the powertrain kinematics. For a series hybrid powertrain, the storage device and alternate power-producing devices can be relied on during transient conditions to produce all of the prime mover power. Powertrains having the power-split arrangements of FIGS. 2-4 can produce between 25% and 100% of prime mover power during transients.

The minimum capacity of the energy storage device 32 is dependent on its duty cycle. For conventional hybrid powertrains operating in the Environmental Protection Agency Metro-Highway Cycle and recovering vehicle kinetic energy through a brake regeneration system, the storage device 32 would have capacity to store approximately the total kinetic energy of the vehicle from 35 to 45 mph, as established by the formula KE=1/2 M V², wherein KE is kinetic energy of the vehicle, M is vehicle mass, and V is vehicle velocity. But an energy storage device 32 for a powertrain according to this invention should have capacity to store more energy than the corresponding capacity of a conventional powertrain in order to provide reserve power for a period equal to the length of the delay of the prime mover in responding to a demand for increased wheel torque.

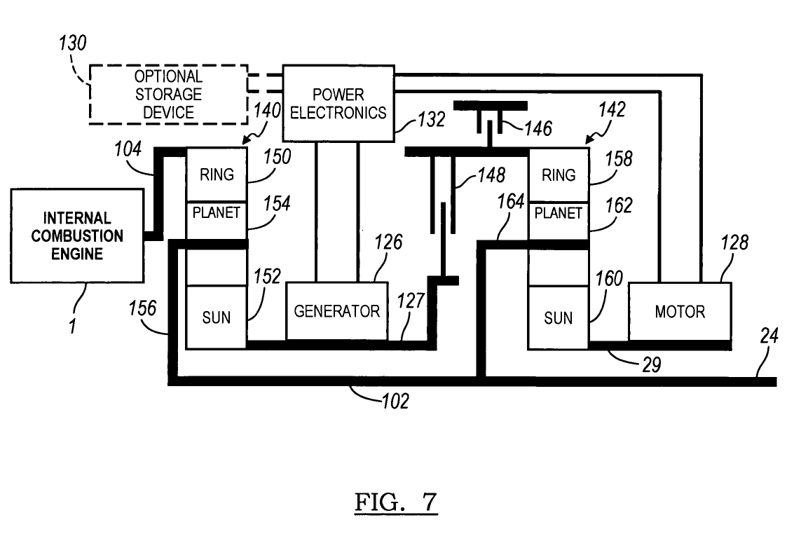

Referring to FIG. 7, a hybrid electric powertrain 100 includes a dual-mode electrically variable transmission 102, which has an input shaft 104 coupled to an internal combustion engine 14. An output shaft 24 of transmission 102 may be coupled to the vehicle drive wheels.

The transmission 102 includes two planetary gearsets 140, 142, an electrical generator 126, and an electrical motor 128 coupled to the gearsets. A storage battery 130 supplies current to machines 126 and 128 when operating in a motoring mode, and receives charging current from those machines when operating in a generating mode. A power electronics control unit 132, including a microprocessor-based controller and suitable inverter circuitry, couples the battery 130 to machines 126, 128, and controls the machines in response to various input signals, including a driver torque request signal and an output shaft speed signal. As illustrated, machines 126, 128 are induction machines, although other configurations are possible. Machine 126 has a fixed stator, electrically coupled to control unit 132, and a rotor mounted on a sleeve shaft 127. Machine 28 has having a stator, electrically coupled to control unit 132, and a rotor mounted on sleeve 129.

The transmission 124 includes a friction brake 146 and friction clutch 148. Each planetary gearset 140, 142 includes an ring gear 150, 158, circumscribing a sun gear 152, 160; planet pinions 154, 162, rotatably mounted on a carrier 156, 164 such that each planet pinion engages both the respective ring gear and sun gear. As shown in FIG. 7, ring gear 50 is coupled to the input shaft 104, the planet carriers 156, 164 are mutually connected for common rotation with output shaft 24, sun gear 152 is coupled to the rotor of electric machine 126 via sleeve shaft 127, and sun gear 160 is coupled to the rotor of electric machine 128 via sleeve shaft 129. Additionally, brake 146 alternately couples ring gear 158 to ground and releases ring gear 158, and clutch 148 alternately couples ring gear 158 to sleeve shaft 127 and releases ring gear 158 and sleeve shaft 127.

A first mode of operation providing Reverse and Low-Forward speed ranges is established by engaging brake 146 and releasing clutch 48. This may be described as an input-split mode, with the gearset 140 operating in a differential mode, and gearset 142 operating in a torque multiplication mode. A second mode of operation providing a High-Forward speed range is established by engaging clutch 48 and releasing brake 46. This may be described as a compound-split mode, with both gearsets 140, 142 operating in a differential mode. A neutral state is established by releasing both brake 146 and clutch 148. Control unit 132 controls engagement and disengagement of brake 146 and clutch 148 by controlling suitable solenoid-operated mechanisms (not shown) for carrying out the desired engagement states. The machines 126 and 128 are also controlled by control unit 132. In the first mode, machine 126 is operated as a generator, and machine 128 is operated as a motor; in the second mode, the machines 126 and 128 are selectively operated in the motoring and generating modes depending on output speed.

When the vehicle is stationary, the engine 14 idles at idle speed, and machine a28 is stationary. In this state, the engine 14 drives machine 126 at an idle speed. For reverse operation, the engine remains at idle speed, and machine 128 is motored in a reverse direction. This has the effect of driving transmission output shaft 24 in reverse and increasing the driven speed of machine 126 in the negative direction. For forward operation, the engine speed is progressively increased to a steady-state running speed, while machine 128 is motored in the forward direction. The increasing engine speed initially drives machine 126 faster in the negative direction, but when the effect of machine 128 becomes dominant, and the driven speed of machine 126 decreases, the transmission output shaft 24 is driven in the forward direction in direct proportion to the motored speed of machine 128. At a predetermined vehicle speed, engine 14 reaches its steady-state running speed. Meanwhile, the motored speed of machine 128 continues to increase until the speed of machine 126 reaches zero at the shift speed. Then the speeds of sun gear 152 and ring gear 158 are substantially equal due to the engagement of brake 146, so that clutch 148 is engaged and brake 146 disengaged with essentially no resulting torque disturbance. The machines 126 and 128 are both motored in the positive direction, even as the speed of machine 128 is decreased due to the differential operation of gearset 142. When the vehicle speed rises, machine 128 is switched to the generator mode, and the motored speed of machine 128 continues to increase to zero. At higher vehicle speeds, machine 128 is motored in the reverse direction to add to the torque produced by machine 126 and engine 14. Finally, machine 126 is switched to the generator mode for still higher vehicle speeds.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

What is claimed is:

1. A powertrain for transmitting power in a vehicle having driven wheels, comprising:
a prime mover having a transient torque response that is equal to or greater than 150 Ms;
a transmission including an input driveably connected to the prime mover and an output driveably connected to the driven wheels, producing a range of ratios of a speed of the output to a speed of the input that varies from negative to positive and includes zero;
a storage device for receiving and producing energy in a predetermined form;
an energy conversion device driveably connected to the prime mover and the drive wheels and transmitting energy to and from storage device, for converting rotational power transmitted to the energy conversion device from the wheels and the prime mover to a form of energy that can be stored in the storage device, and for driving the wheels using energy supplied to the energy conversion device from the storage device; and
a control device for selectively alternately transmitting energy from the storage device to the energy conversion device, and for transmitting energy from the energy conversion device to the storage device.

2. The powertrain of claim 1 wherein the prime mover is a homogeneous charge, compression ignition gasoline fueled engine.

3. The powertrain of claim 1 wherein the prime mover is a homogeneous charge, compression ignition diesel fueled engine.

4. The powertrain of claim 1 wherein the prime mover is a turbocharged diesel cycle or otto cycle engine.

5. The powertrain of claim 1 wherein the prime mover is a Stirling engine.

6. The powertrain of claim 1 wherein the prime mover is a fuel cell stack providing electric power to a series electric transmission.

7. The powertrain of claim 1 wherein the prime mover is an electric motor driveably connected to the driven wheels and driven by an electric generator.

8. The powertrain of claim 1 wherein the storage device is a hydraulic accumulator.

9. The powertrain of claim 1 wherein the storage device is an electric battery assisted by a secondary capacitor stack.

10. The powertrain of claim 1 wherein the storage device is a capacitor stack.

11. The powertrain of claim 1 wherein the storage device is an electric battery.

12. The powertrain of claim 1 wherein the storage device is a flywheel.

13. The powertrain of claim 1 wherein a span of speed ratios produced by the transmission is infinite, and a rotational speed of the output is both underdriven and overdriven relative to a rotational speed of the input.

14. A powertrain for transmitting power in a vehicle having drive wheels, comprising:
a prime mover having a relatively slow transient torque response;
a transmission including an input driveably connected to the prime mover and an output driveably connected to the drive wheels, producing a range of ratios of a speed of the output to a speed of the input that varies from negative to positive and includes zero;
an accumulator for containing pressurized hydraulic fluid;
a hydraulic pump operatively connected to the prime mover;
a hydraulic motor operatively connected to the driven wheels;
a valve block for alternately transmitting energy from the accumulator to the motor, and from the pump to the accumulator and motor.

15. The powertrain of claim 14, wherein the transmission further includes:
a sun gear driveably connected to the driven wheels;
a ring gear driveably connected to the pump;
a set of planet pinions driveably engaged with the sun gear and ring gear, and driveably connected to the prime mover through the input.

16. The powertrain of claim 14, wherein the transmission further includes:
a sun gear driveably connected to the prime mover through the input;
a ring gear driveably connected to the motor;
a set of planet pinions driveably engaged with the sun gear and ring gear, and driveably connected to the driven wheels through the output.

17. The powertrain of claim 14, wherein a span of speed ratios produced by the transmission is infinite, and a rotational speed of the output is both underdriven and overdriven relative to a rotational speed of the input.

18. A powertrain for transmitting power in a vehicle having drive wheels, comprising:
a prime mover having a relatively slow transient torque response;
a transmission including an input driveably connected to the prime mover and an output driveably connected to the drive wheels, producing a range of ratios of a speed of the output to a speed of the input that varies from negative to positive and includes zero, the span of speed ratios being infinite, the output speed being both underdriven and overdriven relative to the speed of the input;
a storage device for receiving and producing energy in electrical form;
an electric generator;
an electric motor driveably connected to the driven wheels;
a controller for alternately transmitting electric energy from the storage device to the motor, and for transmitting electric energy from the generator to the motor and storage device; and
a transmission including an input driveably connected to the prime mover and an output driveably connected to the drive wheels, a sun gear driveably connected to the generator, a ring gear driveably connected to the driven wheels, and a set of planet pinions driveably engaged with the sun gear and ring gear, and driveably connected to the prime mover through the input, producing a range of ratios of a speed of the output to a speed of the input that varies from negative to positive and includes zero.

19. The powertrain of claim 18 wherein a span of speed ratios produced by the transmission is infinite, and a rotational speed of the output is both underdriven and overdriven relative to a rotational speed of the input.
